(19) United States
(12) Patent Application Publication
(10) Pub. No.: US 2010/0059059 A1
(43) Pub. Date: Mar. 11, 2010

(54) HYPERBARIC CHAMBER

(75) Inventor: Keith William Evans, Lake Worth, FL (US)

Correspondence Address: COHEN & GRIGSBY, P.C., 625 LIBERTY AVENUE, PITTSBURGH, PA, 15222-3152, US

(73) Assignee: Perry Baromedical Corporation, Riviera Beach, FL (US)

(21) Appl. No.: 12/207,057

(22) Filed: Sep. 9, 2008

(51) Int. Cl. A61G 10/02

(52) U.S. Cl. 128/205.26

(57) ABSTRACT

A hyperbaric chamber control system. The system includes a computer and a control valve in communication with the computer, wherein the control valve responds to instructions from the computer to control a supply of gas by producing a control signal, and wherein the control valve is configured to operate independently of the computer when a profile is transferred from the computer to the control valve.

### BACKGROUND

Hyperbaric chambers are designed to enable a person in the chamber to breathe pure oxygen at a specific pressure for a specific period of time. The chamber is pressurized and ventilated continuously with pure oxygen and the pressure-time profile (i.e., the rate and direction of pressure change and the time held at any particular pressure), as well as the oxygen ventilation rate of any treatment, are controlled by the chamber's operator. Hyperbaric oxygen administered by a hyperbaric chamber is often used to treat various medical conditions. For example, hyperbaric oxygen may be prescribed for air or gas embolism, decompression sickness, carbon monoxide poisoning, carbon monoxide poisoning complicated by cyanide poisoning, radiation tissue damage, gas gangrene, compromised skin grafts and flaps, crush injuries, compartment syndrome, acute traumatic ischemias, necrotizing soft tissue infections, osteomyelitis, non-healing wounds, exceptional blood loss, intracranial abscesses, thermal burns, and/or any other appropriate condition, as prescribed by an attending physician.

Hyperbaric chambers are designed to be installed and operated primarily in medical facilities and are intended to be operated by trained medical personnel. Such personnel must manually operate the hyperbaric chamber and monitor the patient being treated. Thus, the personnel must set and monitor the treatment parameters while ensuring that the patient is safe and comfortable.

### SUMMARY

In one general aspect, embodiments of the present invention are directed to a hyperbaric chamber control system. The system includes a computer and a control valve in communication with the computer, wherein the control valve responds to instructions from the computer to control a supply of gas by producing a control signal, and wherein the control valve is configured to operate independently of the computer when a profile is transferred from the computer to the control valve.

Those and other details, objects, and advantages of the present invention will become better understood or apparent from the following description and drawings showing embodiments thereof.

### BRIEF DESCRIPTION OF THE DRAWINGS

Various embodiments of the present invention are described herein by way of example in conjunction with the following figures, wherein:

FIG. 1 illustrates a perspective view of a hyperbaric chamber according to one embodiment of the present invention;

FIG. 2 illustrates a hyperbaric chamber electronic control system according to one embodiment of the present invention;

FIGS. 3 and 4 illustrate a diagram of a hyperbaric chamber pneumatic control system and control assembly according to one embodiment of the present invention;

FIG. 5 illustrates a hyperbaric chamber pneumatic control system according to one embodiment of the present invention;

FIG. 6. illustrates a schematic diagram of an electronic controller circuit for a hyperbaric chamber according to one embodiment of the present invention;

FIG. 7 illustrates a schematic diagram of the hyperbaric chamber control assembly according to one embodiment of the present invention;

FIG. 8 illustrates a flowchart of an embodiment of a method for manually operating a hyperbaric chamber;

FIG. 9 illustrates a flowchart of an embodiment of a method for operating a hyperbaric chamber automatically; and

FIG. 10 illustrates a pressure/time profile according to one embodiment of the present invention.

### DESCRIPTION

In general, various embodiments of the present invention are directed to hyperbaric chambers that include electronic control of the pressurization, ventilation and depressurization functions. In various embodiments, predetermined or customized profiles may be used to control chamber pressure and duration by way of electronic, or computer, control of pressurization and depressurization. In various embodiments, the pressure and duration may be controlled manually or automatically in accordance with the profiles.

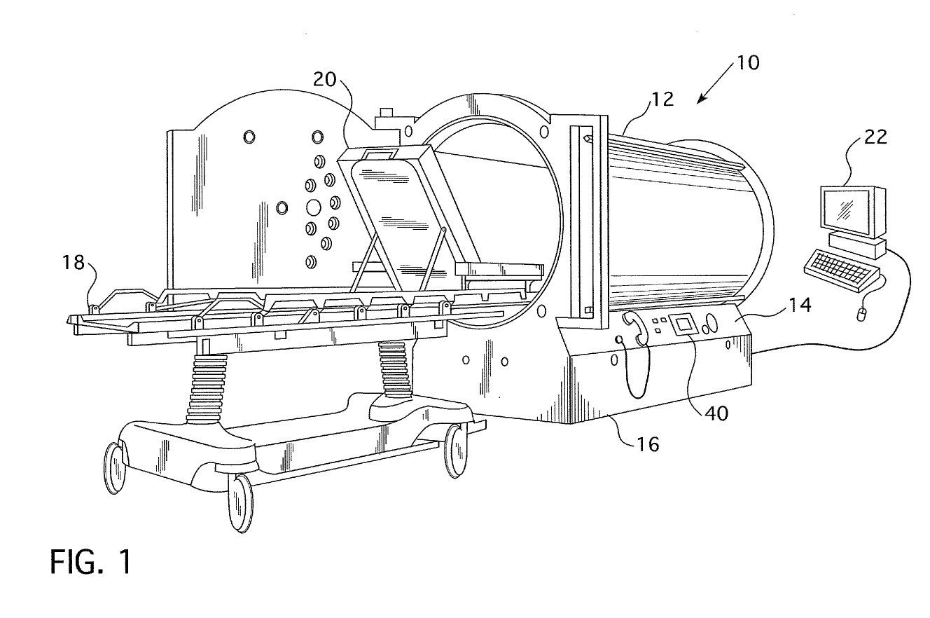

FIG. 1 illustrates a perspective view of a hyperbaric chamber 10 according to one embodiment of the present invention. The chamber 10 includes a pressure vessel 12 and a control assembly 14 that are mounted on a chassis 16. The pressure vessel 12 may include two end heads constructed of, for example, aluminum and a transparent cylinder constructed of, for example, a polymer such as acrylic. A transfer gurney 18 allows for a patient to enter and exit the pressure vessel 12 and a stretcher 20 may be moved into and out of the pressure vessel 12. In one embodiment, the transfer gurney 18 mates to the pressure vessel 12 and locks into position for safe and efficient patient transfer. A pneumatic control system (not shown in FIG. 1) may be located in or on the chassis 16 or may be located on or mounted to a side of the pressure vessel 12. A computer 22, such as a personal computer, may be remotely in communication with the control assembly 14. In various embodiments, operating profiles (i.e., pressurization and depressurization profiles) may be generated and stored in the computer 22. The profiles may be transferred to a computer 42 in the control assembly 14 so that the hyperbaric chamber 10 may be operated according to one or more of the transferred profiles. In one embodiment, the on-board computer 42 is the primary computer for controlling the system.

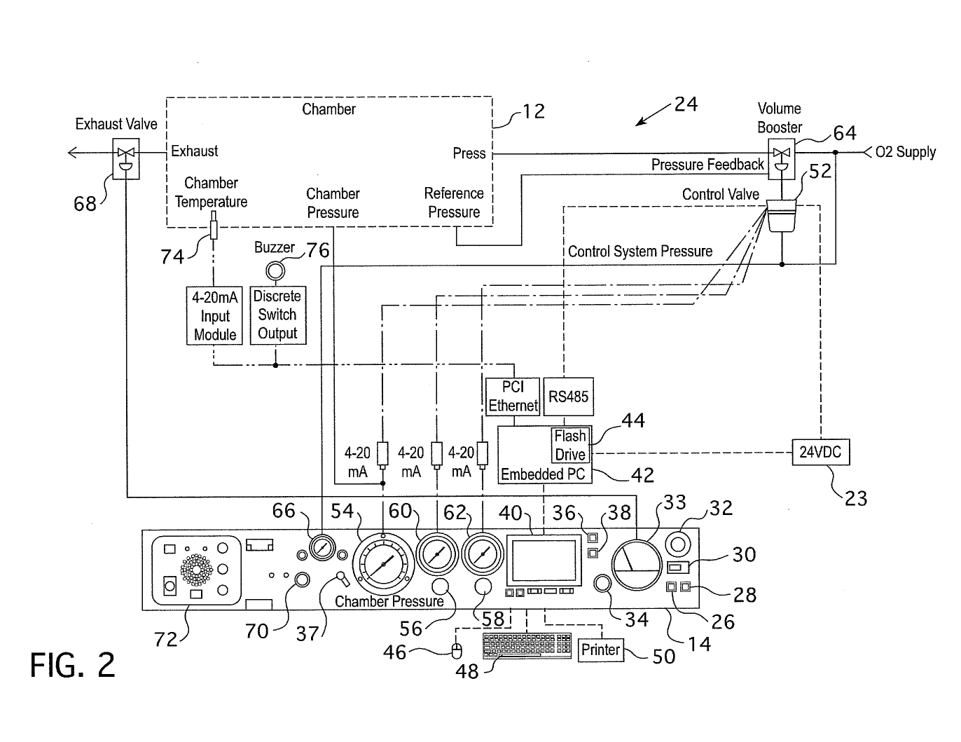

FIG. 2 illustrates a hyperbaric chamber electronic control system 24 according to one embodiment of the present invention. As used throughout the figures herein, solid lines are generally used to illustrate pneumatic lines (piping, tubing, etc.) and dashed lines are generally used to illustrate electrical lines, wires or buses. A power supply 23 supplies power to the various electronic/electrical components of the system 24. The system 24 includes the control assembly 14. The control assembly 14 includes an electrical circuit power button 26, a reset button 28, a cycle counter 30, an emergency stop button 32, a ventilation rate gauge 33, ventilation control knob 34, a start/stop button 36, a main pneumatic circuit power switch 37, an automatic/manual selection switch 38, and a display (e.g., liquid crystal display (LCD)) screen 40. The main pneumatic power switch 37 activates the pneumatic portion of the control system 24. The automatic/manual selection switch 38 may be a momentary switch that is used to select the mode of operation of the control system 24 (i.e., manual or automatic).

The display 40 is in communication with the computer 42, such as an embedded computer, that includes a memory device 44, such as a flash drive. In one embodiment, the computer 42 is a computer manufactured by Blue Chip Technology. Input and output devices, such as mouse 46, keyboard 48 and printer 50 may also be in communication with the control assembly 14, and ultimately the computer 42. The computer 42, in conjunction with the display 40 and input/output devices 46, 48, 50, may be used to execute automatic pressurization and depressurization profiles of the pressure vessel 12. In various embodiments, the profiles are downloaded to the computer 42 and the computer 42 controls a pneumatic control valve 52, which ultimately controls the amount of gas that enters the pressure vessel 12. In one embodiment, the control valve 52 is an ER3000 Electronic Pressure Controller manufactured by Tescom Corporation. The pressure of the pressure vessel 12 is displayed on a gauge 54 and supplied to the control valve 52. The pressure and rate which the operator, in manual mode, sets via controls 56, 58 are displayed on gauges 60, 62 and supplied to the control valve 52.

Supply gas (e.g., Oxygen) is supplied to the system 24 through a volume booster 64 that boosts the volume of the gas for the pressure vessel 12. The supply gas pressure is displayed on a gauge 66 of the control assembly 14. An exhaust valve 68 allows for evacuation of the pressure vessel 12, including when an exhaust bypass control 70 on the control assembly 14 is depressed. The control assembly includes an intercom system 72 that allows the operator of the system 24 to communicate with a person in the pressure vessel 12. The computer 42 monitors the temperature of the pressure vessel 12 using a temperature sensor 74 and provides a digital or graphical readout of the temperature on the display 40. An audible buzzer 76 is used to alert the operator when pre-programmed “air-breaks” are required for the patient.

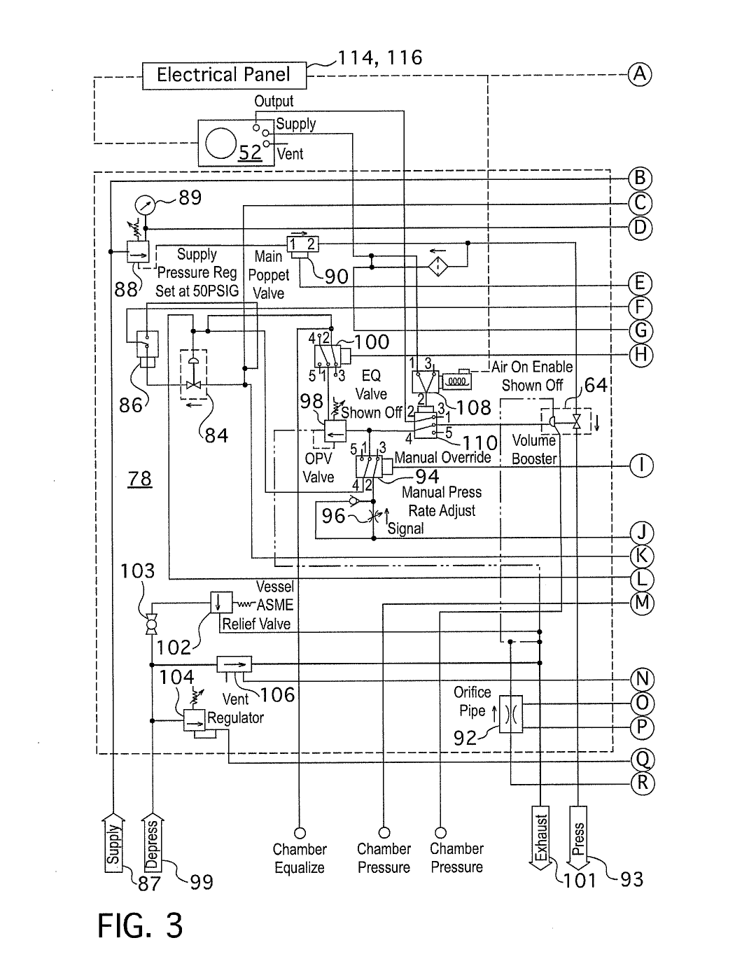

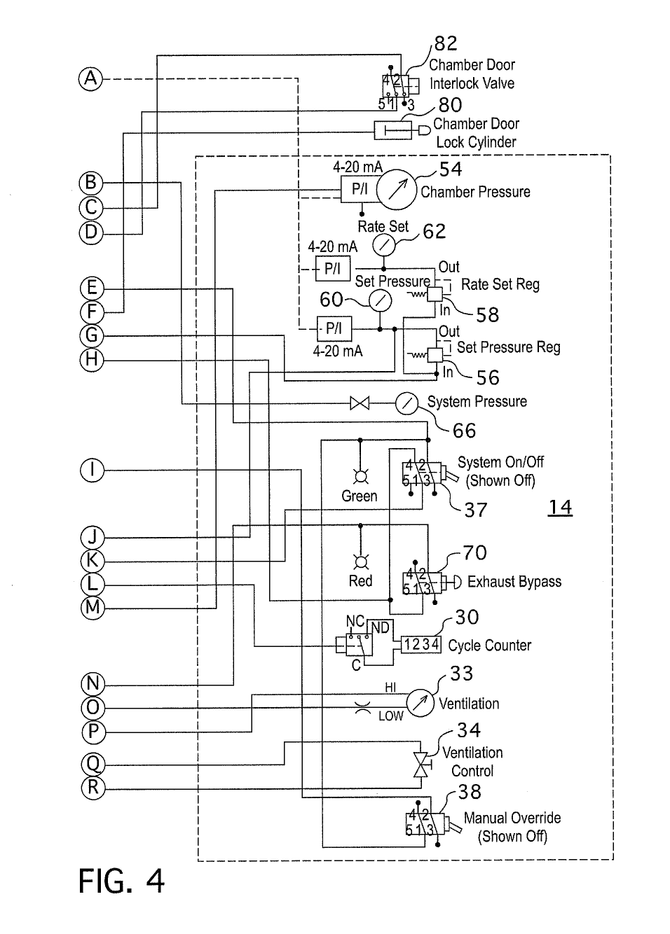

FIGS. 3 and 4 illustrate a diagram of a hyperbaric chamber pneumatic control system 78 and the control assembly 14 according to one embodiment of the present invention. A chamber door lock cylinder 80 locks the door of the pressure vessel 12 and, unless the door is locked and the main power switch 37 is on, the pressure vessel 12 will not be pressurized by operation of an interlock valve 82, a volume booster 84, and a valve 86. The door lock cylinder 80 is activated when pressure in the pressure vessel 12 is pressurized above a minimum threshold (e.g., ½ psig). In various embodiment, the volume booster 84 is a 1:4 multiplying volume booster and in one embodiment is required for activation of the door lock cylinder 80 at the low pressures required.

The supply gas (e.g., oxygen) is supplied through a connection 87 and is regulated to, for example, 50 pounds per square inch (PSIG) by a regulator 88 and the pressure is indicated on a gauge 89. The supply gas passes through a poppet valve 90, which in one embodiment is a two-way ball valve that is activated by the main power switch 37. The volume booster 64 acts as the main control valve for the pressure vessel 12 and an orifice pipe 92 provides a differential pressure reference signal that is indicated on the ventilation rate gauge 33. This ventilation reference is a measure of the total amount of gas passing through the pressure vessel 12. The supply gas enters the pressure vessel 12 through a pressure supply fitting 93. A manual override valve 94 is activated when the automatic/manual switch 38 is set to manual operation and a bleed valve 96 ensures that the pressure in the pressure vessel 12 does not increase above a pre-determined maximum pressurization rate when the pressure vessel 12 is being pressurized in manual mode. During manual operation, a control signal pressure is supplied to the control signal input port of the volume booster 64 through the auto/manual select valve 110 connected to the inlet port of the volume booster 64, An overpressure relief valve 98 ensures that the manual pressure reference signal supplied to the volume booster 64 control signal input port does not exceed a maximum specified operating pressure (e.g., 30 PSIG).

An equalize valve 100 ensures that the pressure of the pressure vessel 12 is available so that, if the user switches the system from automatic mode to manual mode, the pressure in the pressure vessel 12 will remain the same. As can be seen in FIGS. 3 and 4, the pressure vessel 12 is exhausted (i.e., depressurized) from a depressurization connection 99 through an exhaust port 101 if a relief valve (i.e., safety valve) 102, through a chamber stop valve 103, is activated, the ventilation control knob 34 is opened (in such a case the venting is regulated by a regulator 104), or the exhaust bypass control 70 is depressed (activating valve 106). A switch 108 and valve 110 select the output signal from the control valve 52 and pass the output pressure of the control valve 52 to the control signal input port of the volume booster 64 when the system is operating in automatic mode.

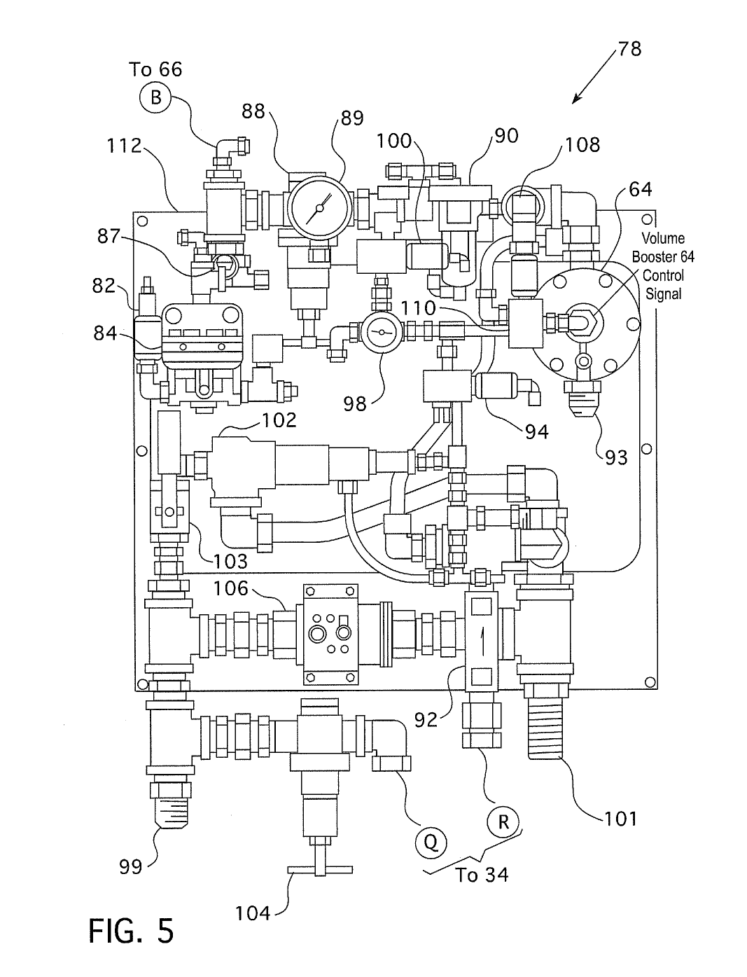

FIG. 5 illustrates the hyperbaric chamber pneumatic control system 78 according to one embodiment of the present invention. The various components of the system 78 are mounted on a mounting panel 112, which may be mounted, for example, on an end of the pressure vessel 12 or on the chassis 16 of the chamber 10.

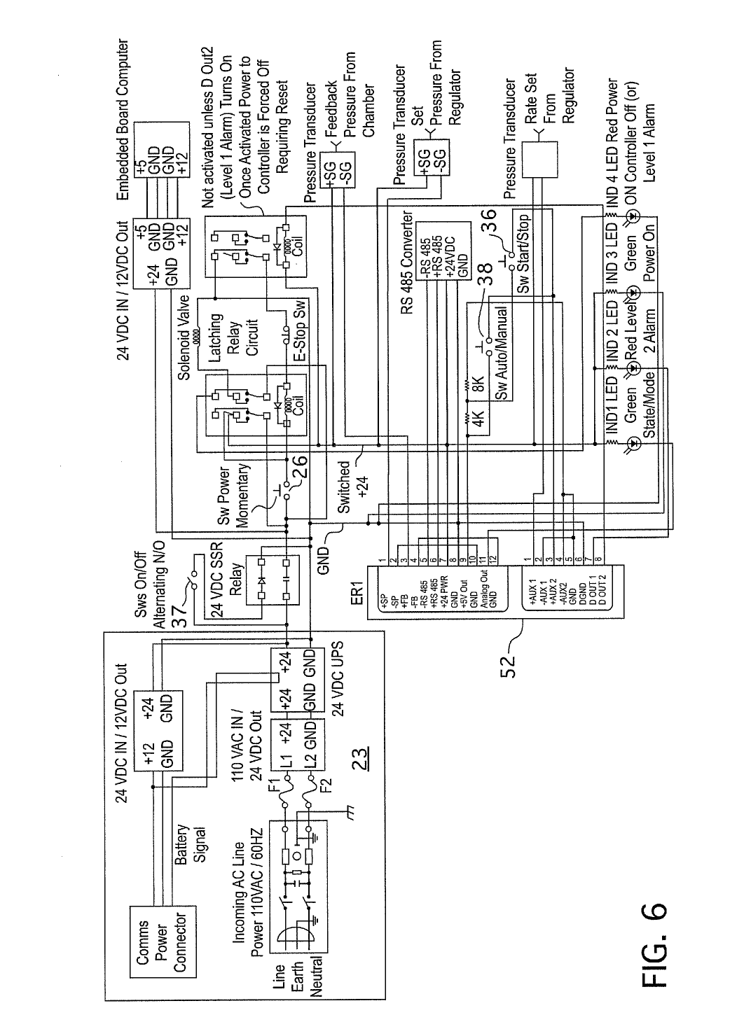

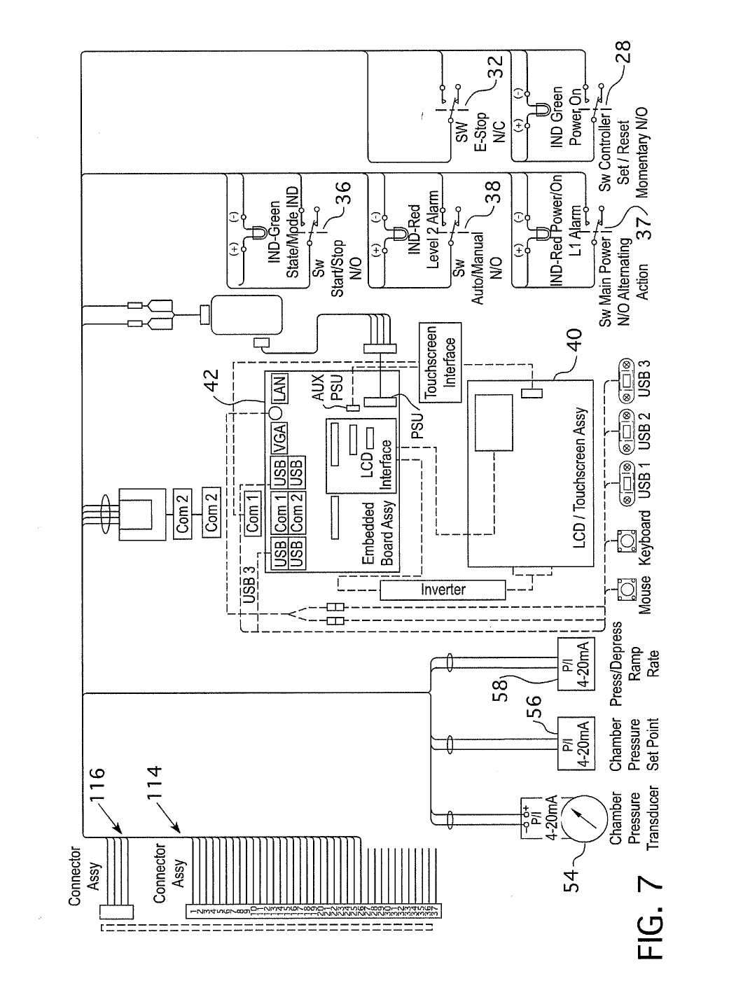

FIG. 6. illustrates a schematic diagram of an electronic controller circuit for a hyperbaric chamber according to one embodiment of the present invention. FIG. 7 illustrates a schematic diagram of the hyperbaric chamber control assembly 14 according to one embodiment of the present invention. Connector assemblies 114, 116 connect the various electrical components of the control assembly 14.

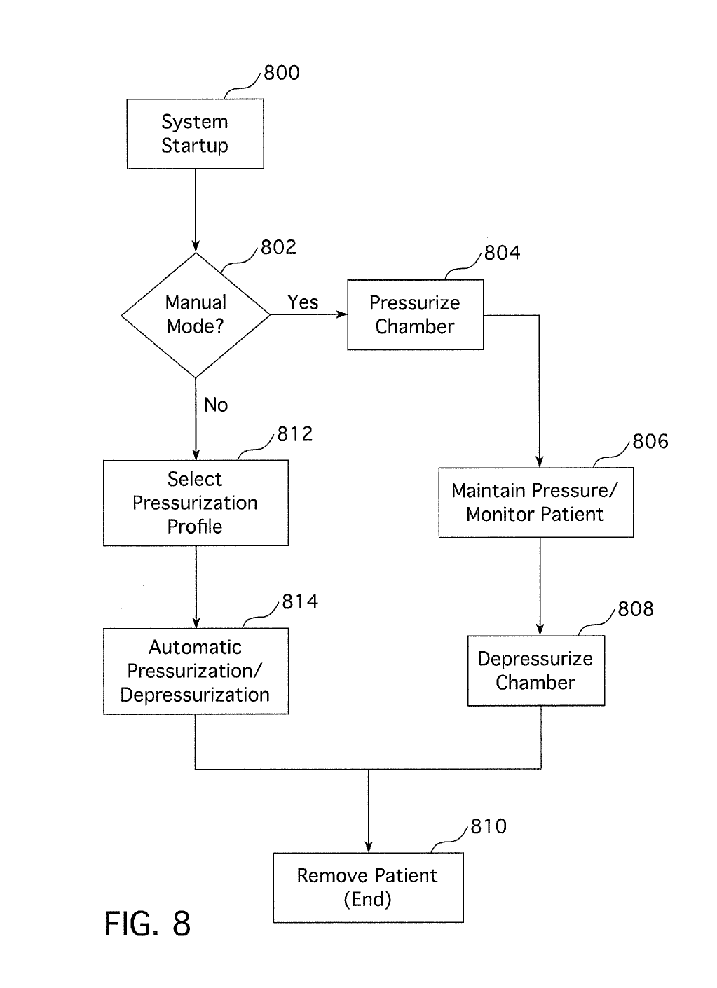

FIG. 8 illustrates a flowchart of an embodiment of a method for manually operating a hyperbaric chamber. At 800, the system is started using a startup procedure. For example, the main oxygen supply valve is opened, the pneumatic circuit power switch 37 is turned on, the breathing air supply valve for an air breathing mask, if used, is opened, and the gauge 66 is examined to ensure that the supply pressure is between certain values (e.g., 50 and 90 psig). In one embodiment the electrical circuit momentary power switch 26 is pressed, providing electrical power to the balance of the control system 24, and then the reset switch 28 is pressed, providing electrical power to the control valve 52. At 802, it is determined if the system is operating in manual or automatic mode based on the position of the automatic/manual selection switch 38.

If the system is operating in manual mode, at 804 the pressure vessel 12 can be pressurized after the patient is loaded into the pressure vessel 12 and all safety checks are performed. As required for the specific treatment desired, the rate set knob 58 is adjusted to the desired pressurization rate and the set pressure knob 56 is adjusted to the desired treatment pressure. At 806, the pressure of the pressure vessel 12 is maintained and the patient is monitored. The pressure may be adjusted using the set pressure knob 56. Also, the pressure vessel 12 may be cooled by increasing the ventilation rate using the ventilation control knob 34.

At the conclusion of the patient treatment (or before if desired), the pressure vessel 12 is depressurized at 808. Depressurization is accomplished by the rate set knob 58 being adjusted to the desired depressurization rate and the set pressure knob 56 being adjusted to zero psig. When the pressure of the pressure vessel reaches a certain threshold (in one embodiment 1 psig), the exhaust bypass button 70 may be depressed, with the pneumatic circuit power switch 37 set to off, to fully depressurize the pressure vessel 12. At 810, the patient may be removed when the pressure of the pressure vessel 12 is zero. The system may then be powered down by turning the pneumatic power switch 37 to off, turning the control assembly 14 power switch 26 to off, and closing the oxygen supply valve.

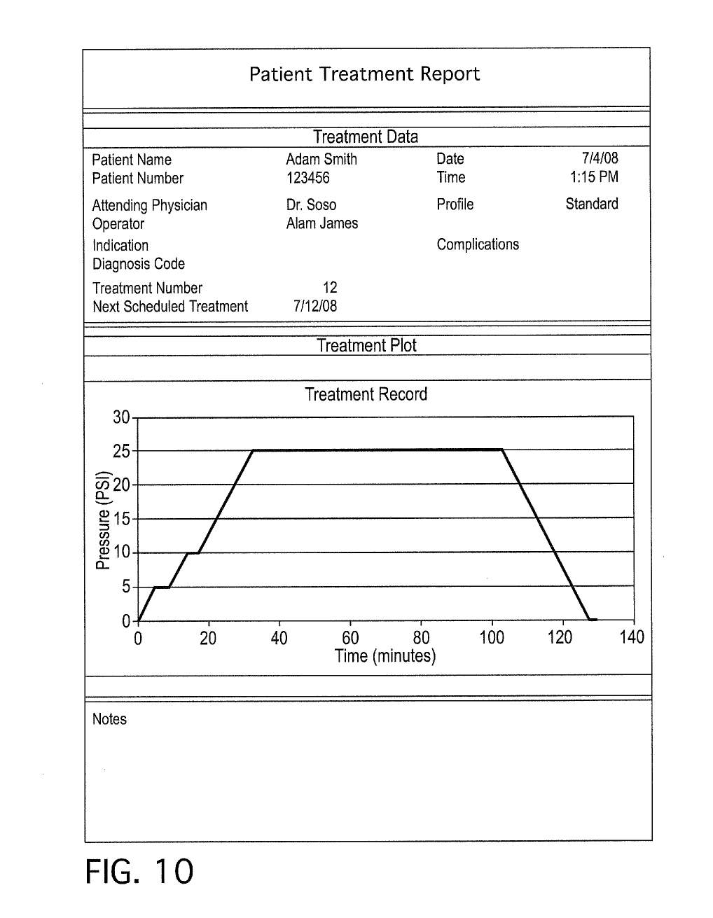

If it is determined at 802 that the system is not operating in manual mode (i.e., it is operating in automatic mode), a pre-programmed pressurization/depressurization profile is selected by the system operator at 812 via, for example, the display screen 40. The profiles from which the operator chooses may be stored in the memory device 44 of the computer 42. In one embodiment, each profile is a graphical representation of a treatment profile and contains parameters such as desired pressures, rates of change and duration of dwells, an example of which is shown in FIG. 10. In one embodiment, a profile with certain constraints on the parameters may be created and loaded into the memory 44 of the computer 42. Upon selection of the desired profile, the selected profile is downloaded into the control valve 52. At 814, when the start/stop button 36 is pressed, the system executes the profile by instructing the control valve 52 to pressurize and depressurize the pressure vessel 12 at specific ramp rates according to the selected downloaded profile. When the pressure vessel 12 is depressurized, the patient is removed and the system may be powered down.

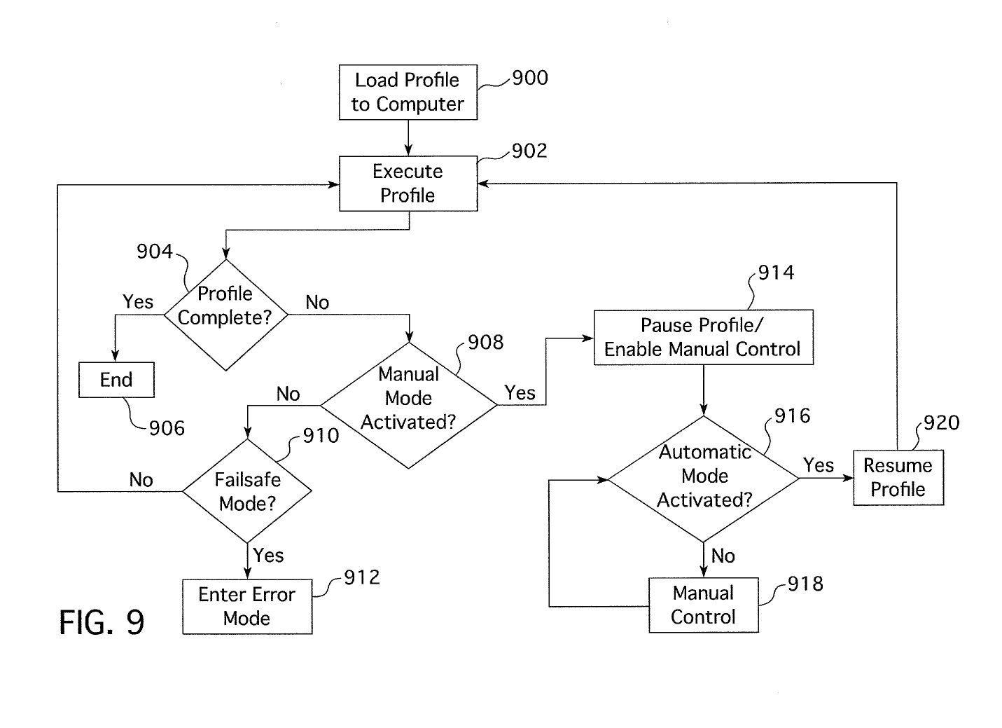

FIG. 9 illustrates a flowchart of an embodiment of a method for operating a hyperbaric chamber automatically. At 900 the desired profile is loaded into the memory device 44 of the computer 42, and subsequently downloaded into the control valve 52. At 902 the profile is executed by instructing the control valve 52 to pressurize the pressure vessel 12. At 904 the process determines whether the profile has been completed. If so, the process ends at 906. If the profile has not been completed, it is determined if manual mode has been activated by a depression of the automatic/manual selection switch 38. If manual mode has not been activated, the process determines at 910 whether an error has occurred for which a failsafe mode should be entered. Examples of errors include system power loss, activation of system (controller reset) when chamber 12 pressure is greater than 0 psig, pressure vessel pressure outside a maximum range, signal loss, or rate of change greater or lower than specified.

If an error has occurred, an error mode is entered at 912. If no error has occurred, profile execution continues at 902. If manual mode has been activated as determined at 908, at 914 profile execution is paused by the computer 42 and manual control is enabled so that the operator may manually control pressure and rate. At 916 it is determined if automatic mode has been reactivated by a depression of the automatic/manual selection switch 38. If not, manual control is continued at 918. If automatic mode has been reactivated, the profile is resumed at 920 and the profile is executed at 902.

In various embodiments and by way of example, a system may be constructed according to the teachings herein that has the following characteristics and operating parameters: (1) input supply pressure is between 50 and 90 psig; (2) operational temperature is between 50° F. and 100° F.; (3) operational relative humidity between 5% and 95%, non-condensing; (4) operational gas may be 100% oxygen, 100% nitrogen, or atmospheric air; (5) controlled flow capacity may be up to 50 SFCM; (6) output pressure may be controlled from 0 psig to 30 psig; and (7) the rate of pressure change may be controlled between 0 psig and 5 psig.

While several embodiments of the invention have been described, it should be apparent that various modifications, alterations and adaptations to those embodiments may occur to persons skilled in the art with the attainment of some or all of the advantages of the present invention. It is therefore intended to cover all such modifications, alterations and adaptations without departing from the scope and spirit of the present invention.

What is claimed is:

1. A hyperbaric chamber control system, the system comprising:
a computer; and
a control valve in communication with the computer, wherein the control valve responds to instructions from the computer to control a supply of gas by producing a control signal, and wherein the control valve is configured to operate independently of the computer when a profile is transferred from the computer to the control valve.

2. The hyperbaric chamber control system of claim 1, wherein the control valve is configured to store an applicable command set and one of a software subroutine and a firmware subroutine.

3. The hyperbaric chamber control system of claim 1, wherein the control valve has stored thereon one of customized software and customized firmware.

4. The hyperbaric chamber control system of claim 1, wherein the control valve is in communication with a booster valve, and wherein the control signal is supplied to the booster valve.

5. The hyperbaric chamber control system of claim 1, further comprising a display device in communication with the computer.

6. The hyperbaric chamber control system of claim 1, wherein the computer is an embedded personal computer.

7. The hyperbaric chamber control system of claim 1, wherein the computer comprises a memory device that is adapted to store at least one profile that, when executed, provides instructions to the control valve.

8. A hyperbaric chamber system, comprising:
a pressure vessel; and
a hyperbaric chamber control system, the hyperbaric chamber control system comprising:
a computer; and
a control valve in communication with the computer, wherein the control valve responds to instructions from the computer to control a supply of gas by producing a control signal, and wherein the control valve is configured to operate independently of the computer when a profile is transferred from the computer to the control valve.

9. The hyperbaric chamber system of claim 8, wherein the control valve is configured to store an applicable command set and one of a software subroutine and a firmware subroutine.

10. The hyperbaric chamber system of claim 8, wherein the control valve has stored thereon one of customized software and customized firmware.

11. The hyperbaric chamber system of claim 8, further comprising a booster valve in communication with the control valve.

12. The hyperbaric chamber system of claim 11, wherein the control signal is supplied to the booster valve.

13. The hyperbaric chamber system of claim 8, further comprising a display device in communication with the computer.

14. The hyperbaric chamber system of claim 8, wherein the computer is an embedded personal computer.

15. The hyperbaric chamber system of claim 8, wherein the computer comprises a memory device that is adapted to store at least one profile that, when executed, provides instructions to the control valve.

16. A hyperbaric chamber control system, the system comprising:
a computer; and
valve means in communication with the computer, wherein the valve means responds to instructions from the computer to control a supply of gas by producing a control signal, and wherein the valve means is configured to operate independently of the computer when a profile is transferred from the computer to the valve means.
